(19) United States
(12) Patent Application Publication
(10) Pub. No.: US 2019/0310750 A1
(43) Pub. Date: Oct. 10, 2019

(54) ELECTRONIC DEVICE, METHOD FOR CONTROLLING THE SAME, AND STORAGE MEDIUM

(71) Applicant: CANON KABUSHIKI KAISHA, Tokyo (JP)

(72) Inventor: Koichi Okada, Kunitachi-shi (JP)

(21) Appl. No.: 16/452,356

(22) Filed: Jun. 25, 2019

Related U.S. Application Data
(63) Continuation of application No. PCT/JP2017/045419, filed on Dec. 19, 2017.

(30) Foreign Application Priority Data
Dec. 27, 2016 (JP) 2016-253006

(51) Int. Cl. G06F 3/0485; G06F 3/0488; G06F 3/041

(52) U.S. Cl. CPC G06F 3/0485; G06F 3/0414; G06F 3/04886

(57) ABSTRACT

An electronic device according to the present invention includes a display control unit that implements control such that a second display target is displayed in an area of a first display target, and a control unit that implements control such that a display range of the first display target is changed together with a change in a display position of the second display target in response to a touch with the operation surface and a change in a touch position at less than a predetermined pressing force, and such that a display range of the second content is changed without movement of a part of the first display target outside the second display target in response to a touch with the operation surface and a change in the touch position at the predetermined pressing force or more.

### CROSS-REFERENCE TO RELATED APPLICATIONS

This application is a Continuation of International Patent Application No. PCT/JP2017/045419, filed Dec. 19, 2017, which claims the benefit of Japanese Patent Application No. 2016-253006, filed Dec. 27, 2016, both of which are hereby incorporated by reference herein in their entirety.

### TECHNICAL FIELD

The present invention relates to an electronic device, a method for controlling the electronic device, a program, and a storage medium.

### BACKGROUND ART

A touch screen has been recently used as an interface for operating an electronic device. The touch screen enables various kinds of operation to be performed by a single input device in conjunction with a screen image that is displayed on an operation surface. In some cases, the touch screen makes operation complicated. For example, when a WEB page is viewed by a smart phone, operation (scroll operation) of moving a finger upward from below on the touch screen scrolls the screen image. However, when there is another scroll screen image that can be scrolled in the WEB page, the target of the scroll operation is divided into the WEB page itself and the other scroll screen image, and the other scroll screen image is scrolled even when the WEB page is to be scrolled in some cases.

PTL 1 discloses a scroll device that detects that plural locations are touched at the same time and that determines a scroll instruction for scrolling in order to distinguish scroll operation by sliding fingers on the touch screen from drag operation of an object.

However, the scroll device in PTL 1 has problems in that it is necessary for the operation to change the number of the fingers, and usability is poor because a pen input cannot be used for the operation.

An object of the present invention is to provide an electronic device that enables a process that a user desires to be performed in response to touch operation, a method for controlling the electronic device, and a storage medium.

### CITATION LIST

### Patent Literature

PTL 1: Japanese Patent Laid-Open No. 11-102274

### SUMMARY OF INVENTION

To solve the above problem and achieve the above object, an electronic device according to the present invention includes a touch-detecting unit that is capable of detecting a touch with a display unit, and a control unit that controls the display unit such that the display unit displays a content. When a second content is displayed in an area within a first content, the control unit controls the display unit such that a display range of the first content is changed together with a change in a display position of the second content in response to a touch with the operation surface at less than a predetermined pressing force and a change in a touch position, and such that a display range of the second content is changed without movement of a part of the first content outside the second content in response to a touch with the operation surface at the predetermined pressing force or more and a change in the touch position.

Further features of the present invention will become apparent from the following description of exemplary embodiments with reference to the attached drawings.

### BRIEF DESCRIPTION OF DRAWINGS

FIG. 1 is a block diagram illustrating an example of the structure of an electronic device.

FIG. 2 is a flowchart illustrating an example of a display control process.

FIG. 3 is a flowchart illustrating an example of a touch input control process.

FIG. 4 is a flowchart illustrating an example of a tap determination process.

FIG. 5 is a flowchart illustrating an example of a multi touch process.

FIG. 6 is a flowchart illustrating an example of a single tap process.

FIG. 7A illustrates a display example of a display.

FIG. 7B illustrates a display example of the display.

FIG. 7C illustrates a display example of the display.

FIG. 7D illustrates a display example of the display.

FIG. 7E illustrates a display example of the display.

FIG. 8A illustrates a display example of the display.

FIG. 8B illustrates a display example of the display.

FIG. 8C illustrates a display example of the display.

FIG. 8D illustrates a display example of the display.

### DESCRIPTION OF EMBODIMENTS

### First Embodiment

Embodiments of the present invention will hereinafter be described with reference to the drawings.

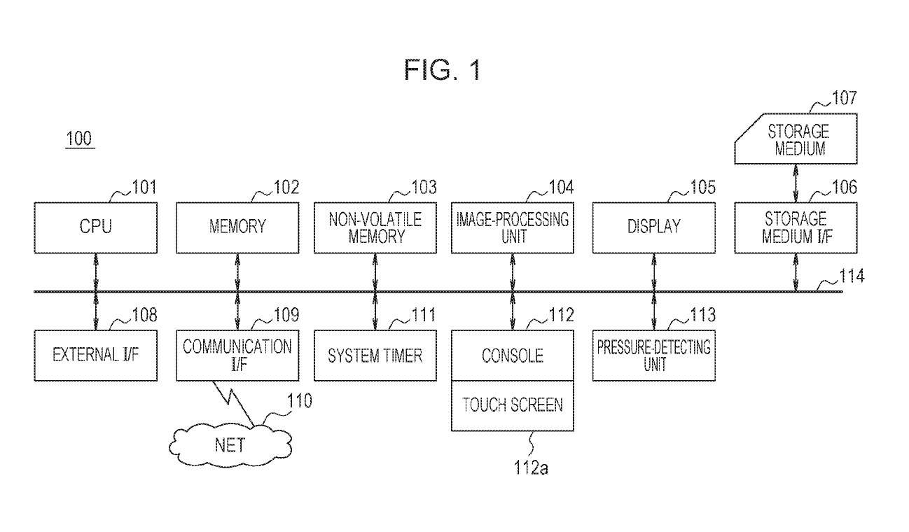

FIG. 1 is a block diagram illustrating an example of the structure of an electronic device 100 according to the present embodiment. The electronic device 100 is described herein as a smart phone by way of example.

The electronic device 100 includes a CPU 101, a memory 102, a non-volatile memory 103, an image-processing unit 104, a display 105, a storage medium I/F 106, an external I/F 108, a communication I/F 109, a system timer 111, a console 112, and a pressure-detecting unit 113. These components are connected by an internal bus 114 and can transmit data to and receive data from each other via the internal bus 114.

The CPU 101 controls the entire electronic device 100. Specifically, the CPU 101 controls the components of the electronic device 100 in accordance with a program that is stored in the non-volatile memory 103.

The memory 102 is used as a work memory of the CPU 101. An example of the memory 102 is a RAM (such as a volatile memory that uses a semiconductor element).

The non-volatile memory 103 stores image data, sound data, other data (a threshold and a setting time of a timer) and various programs for operation of the CPU 101. Examples of the non-volatile memory 103 include a hard disk (HD) and a ROM.

The image-processing unit 104 performs various image processes on image data that is stored in the non-volatile memory 103 and a storage medium 107, an image signal that is obtained via the external I/F 108, and image data that is obtained via the communication I/F 109 on the basis of control of the CPU 101. The image processes that are performed by the image-processing unit 104 include an A/D conversion process, a D/A conversion process, an encoding process for image data, a compression process, a decoding process, a scaling up/scaling down process (resizing), a noise reduction process, and a color conversion process. The image-processing unit 104 may include an exclusive circuit block for a specific image process. Each image process may be performed by the CPU 101 in accordance with a program instead of the image-processing unit 104 depending on the kind of the image process.

The display 105 displays a GUI screen image that includes an image and a GUI (Graphical User Interface) on the basis of control of the CPU 101. The CPU 101 controls the components of the electronic device 100 such that a display control signal is generated in accordance with a program, and an image signal for display on the display 105 is generated and outputted to the display 105. The display 105 displays an image on the basis of the outputted image signal. The electronic device 100 itself may include an interface for outputting the image signal for display on the display 105, and the display 105 may include an external monitor (such as a television).

The storage medium 107 such as a memory card, a CD, or a DVD can be installed in the storage medium I/F 106. The storage medium I/F 106 reads data from the installed storage medium 107 and writes data into the storage medium 107 on the basis of control of the CPU 101. The external I/F 108 is an interface for input and output of the image signal and the sound signal against the external device. The external I/F 108 is connected to an external device by using a wired cable or wirelessly.

The communication I/F 109 is an interface for communication with, for example, an external device or the internet 110 to transmit or receive various kinds of data such as a file and a command.

The system timer 111 measures time for various kinds of control or time of a timepiece that is contained therein.

The console 112 is a character information input device such as a keyboard, or an input device for receiving user operation that includes a pointing device such as a mouse or a touch screen, a button, a dial, a joystick, a touch sensor, or a touch pad. A touch screen 112a that can detect contact with the display 105 is included as an example of the console 112. The touch screen 112a and the display 105 can be integrally formed. For example, the touch screen 112a has a light transmittance that does not impede display on the display 105 and is disposed on an upper layer of a display surface of the display 105. Input coordinates on the touch screen 112a are associated with display coordinates on the display 105. This achieves a GUI as if a user can directly operate a screen image that is displayed on the display 105 by using the GUI. The touch screen 112a can detect a touch with the operation surface of the display 105. The CPU 101 can detect the following operation or states on the basis of the touch that is detected by the touch screen 112a.

The touch screen 112a is not touched with a finger or a pen, and the touch screen 112a is subsequently touched with a finger or a pen. That is, a touch starts (referred to below as touch-down).

The touch screen 112a is being touched with the finger or the pen (referred to below as touch-on).

The finger or the pen moves with the touch screen 112a touched with the finger or the pen (referred to below as touch-move).

The finger or the pen with which the touch screen 112a is touched is released therefrom. That is, the touch ends (referred to below as touch-up).

The touch screen 112a is not touched (referred to below as touch-off).

When the touch-down is detected, the touch-on is detected at the same time. After the touch-down, the touch-on typically continues to be detected unless the touch-up is detected. The touch-move is detected with the touch-on detected. The touch-move is not detected unless a touch position changes even when the touch-on is detected. After the touch-up of all of the fingers or the pen with which the touch screen is touched is detected, the state becomes the touch-off.

The above operation, or the states, and position coordinates at which the touch screen 112a is touched with each finger or the pen are transmitted from the touch screen 112a to the CPU 101 via the internal bus 114. The CPU 101 determines which operation is carried out on the touch screen 112a on the basis of information that is transmitted. Regarding the touch-move, the CPU 101 can determine the direction in which the finger or the pen moves on the touch screen 112a on the basis of variation in the position coordinates, the direction being divided into a vertical component and a horizontal component on the touch screen 112a. When the state transits from the touch-down to the touch-move within a certain distance and to the touch-up on the touch screen 112a, a stroke is drawn. Operation of drawing the stroke quickly is referred to as a flick (flick operation). The flick is operation in which the finger quickly moves a certain distance with the touch screen 112a touched with the finger and is released as it is. In other words, the operation is such that the finger quickly slides on the touch screen 112a so as to flick. The CPU 101 determines that the flick occurs in the case where the touch-move at a predetermined speed or more and a predetermined distance or more is detected and the touch-up is detected as it is. The CPU 101 determines that a drag occurs in the case where the touch-move at less than the predetermined speed and the predetermined distance or more is detected. The CPU 101 can detect plural touch positions (touch input number) at the same time and can detect plural kinds of touch operation. For example, the CPU 101 determines that pinch-in occurs in the case where the touch operation that is detected is that plural points (for example, two points) are touched at the same time and the touch positions thereof approach each other and determines that pinch-out occurs in the case where the touch operation that is detected is that the touch positions are separated from each other. The pinch-out and the pinch-in are referred to as a pinch (or pinch operation). The CPU 101 determines that a single tap (or single tap operation) occurs in the case where the touch operation that is detected is a combination of the touch-down and the touch-up. The CPU 101 determines that a double tap (or double tap operation) occurs in the case where the touch operation that is detected is that the touch-down and the touch-up are repeated two times within a predetermined period.

The touch screen 112a may be any one of a resistive layer touch screen, an electrostatic capacity touch screen, a surface acoustic wave touch screen, an infrared touch screen, an electromagnetic induction touch screen, an image recognition touch screen, and an optical sensor touch screen. These are divided into a touch screen that detects the touch by contact with the touch screen 112a and a touch screen that detects the touch by the finger or the pen approaching the touch screen 112a. However, any one of these is acceptable.

The pressure-detecting unit 113 detects a pressing force against the operation surface of the display 105. The pressure-detecting unit 113 can continuously detect the intensity of the pressing force when the display 105 is pressed by the touch operation. Examples of the pressure-detecting unit 113 can include a strain gauge sensor or an electrostatic capacity sensor. In the case where the strain gauge sensor is used, the strain gauge sensor is disposed at a portion that is strained by the pressing force against the operation surface of the display 105, and the pressing force against the operation surface of the display 105 is detected by using the output of the strain gauge sensor. In the case where the electrostatic capacity sensor is used, the electrostatic capacity sensor is disposed parallel to the display 105. The operation surface is strained by the pressing force against the operation surface of the display 105, and the distance between the finger on the operation surface and the electrostatic capacity sensor is calculated from the value of electrostatic capacity. The pressing force may be detected on the basis of the calculated distance. The pressing force may be detected by using the calculated distance in the same manner as pressure. The pressure-detecting unit 113 may be another pressure-detecting unit, provided that the pressing force against the operation surface of the display 105 can be detected. The pressure-detecting unit 113 and the touch screen 112a may be integrally formed.

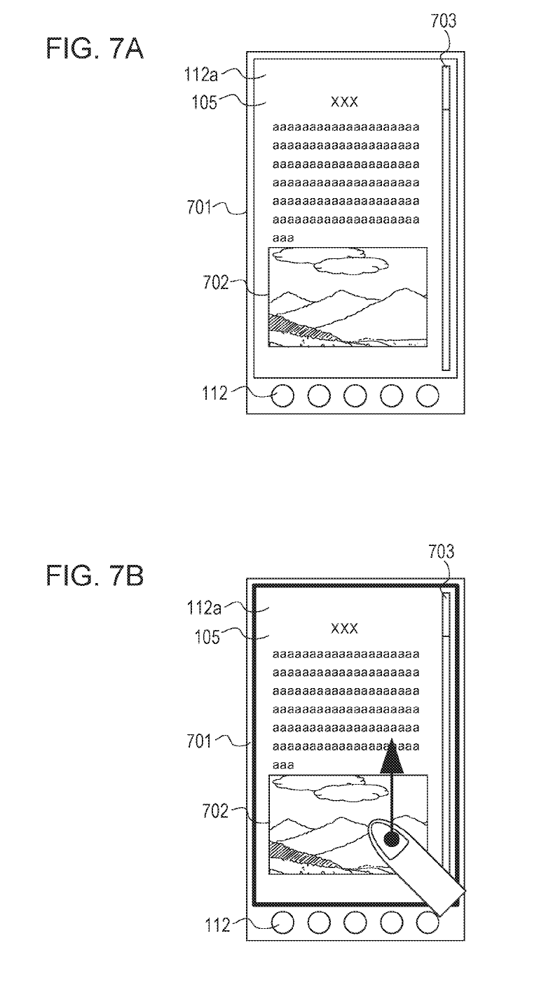

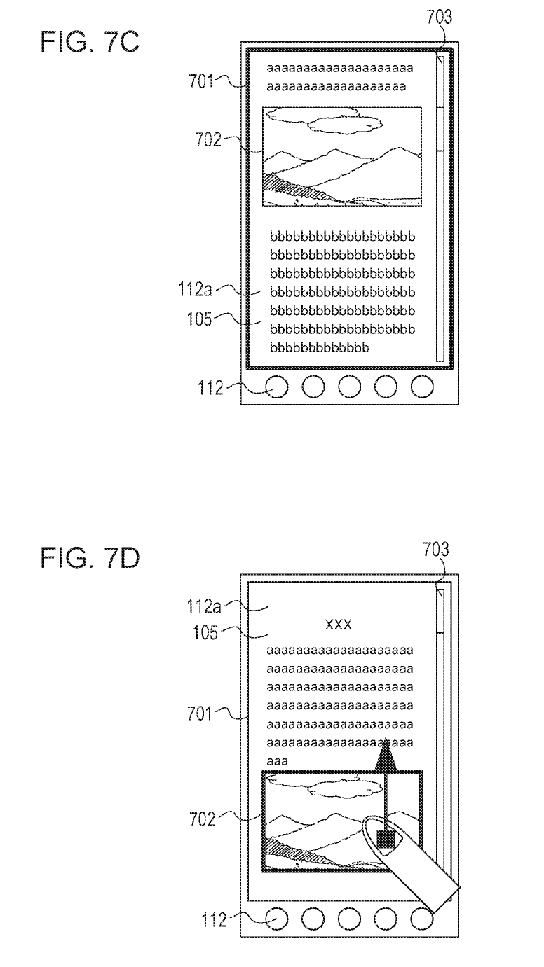

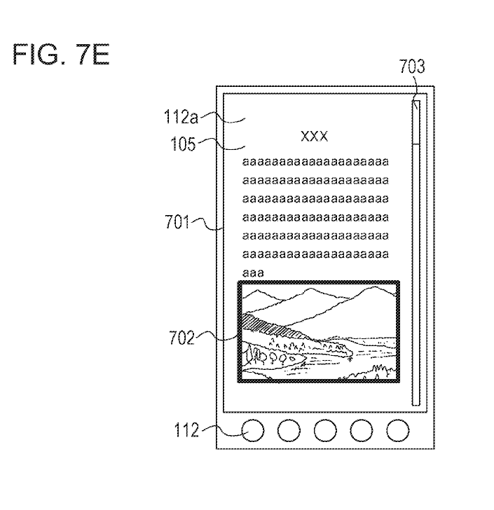

FIG. 7A illustrates an example of the screen image that is displayed on the display 105.

A first display area 701 is displayed on the display 105 that includes the touch screen 112a and contains a second display area 702. The second display area 702 is contained in the first display area 701 and can be scrolled separately from the first display area 701. A scroll bar 703 enables the display target that is displayed in the first display area 701 to be scrolled and represents the position of the entire display area for the display target that is displayed on the display 105.

For example, a WEB page, which is a document that includes, for example, letters, an image, and map data, is displayed in the first display area 701, and an image that is arranged in a part of the Web page is displayed in the second display area 702. At least a part of an omnidirectional image that is captured by an omnidirectional camera or an omnidirectional image that is created by computer graphics, in addition to a typical captured image or video, can be displayed as the image that is displayed in the second display area 702. The content that is displayed in the second display area 702 may be letters or map data in addition to an image, provided that the content is the display target that can be scrolled.

According to the present embodiment, a control target that is scrolled is switched depending on the pressing force of the touch regardless of the touch position, provided that the touch is within the first display area 701 when the touch-move occurs on the operation surface of the display 105.

When the second display area 702 in the first display area 701 is touched and the touch-move occurs at a weak pressing force as illustrated in FIG. 7B, as illustrated in FIG. 7C, the entire display target that is displayed in the first display area 701 is scrolled. That is, the display target such as letters in the first display area 701 and the second display area 702 itself are scrolled together in response to the touch-move. Accordingly, as illustrated in FIG. 7B to FIG. 7C, the display position of the second display area 702 with respect to the first display area 701 changes before and after scrolling.

When the second display area 702 in the first display area 701 is touched and the touch-move occurs at a strong pressing force as illustrated in FIG. 7D, as illustrated in FIG. 7E, only the display target that is displayed in the second display area 702 is scrolled. That is, the display target, such as letters, which is displayed in the first display area 701 and outside the second display area 702 is not scrolled, and the display position of the second display area 702 with respect to the first display area 701 does not change. Only the display target in the second display area 702 is scrolled in response to the touch-move. Accordingly, as illustrated in FIG. 7D to FIG. 7E, the display position of the second display area 702 with respect to the first display area 701 does not change before and after scrolling.

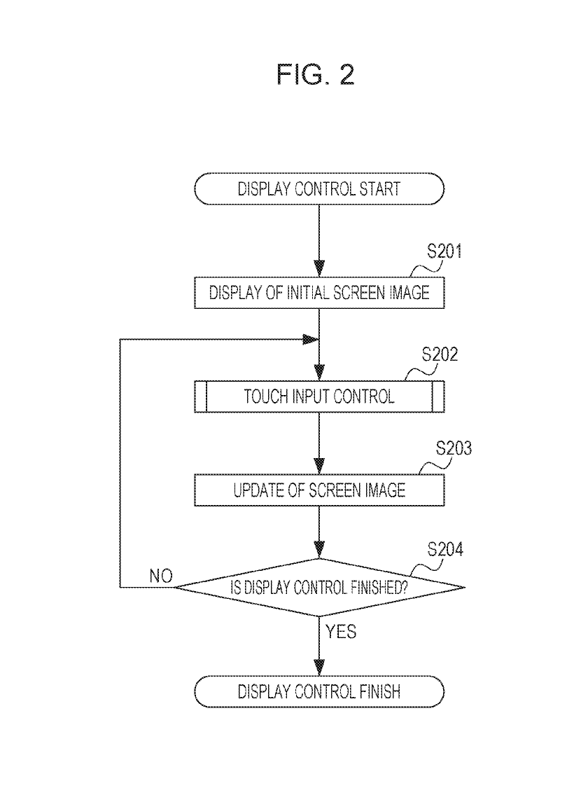

Flowcharts for the display control described with reference to FIG. 7A to FIG. 7E will now be described with reference to FIG. 2 to FIG. 6. The processes in the flowcharts in FIG. 2 to FIG. 6 are performed in a manner in which the CPU 101 loads a program that is stored in the non-volatile memory 103 onto the memory 102 and executes the program.

The processes in the flowchart in FIG. 2 begin with reception of an instruction for causing the display 105 to display the content such as the WEB page by using, for example, browser software after the electronic device 100 starts up. The content includes the display target, such as letters, which is displayed in the first display area 701 and the display target, such as an image, which is displayed in the second display area 702.

At S201, the CPU 101 causes the display 105 to display an initial screen image. For example, when the WEB page is displayed, as illustrated in FIG. 7A, the initial screen image that is displayed is an image at the start position of the WEB page.

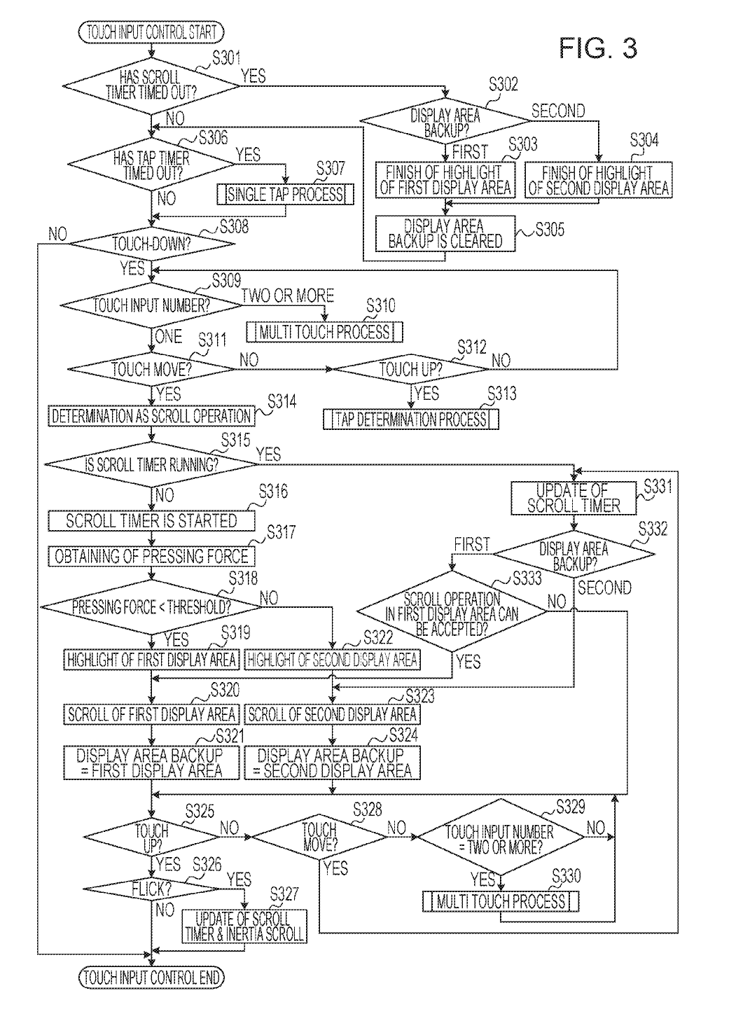

At S202, the CPU 101 implements touch input control. A touch input control process will be described later with reference to the flowchart illustrated in FIG. 3.

At S203, the CPU 101 updates the screen image on the basis of the result of the touch input control.

At S204, the CPU 101 determines whether the display control is finished. In the case where the display control is not finished, the processes at S202 to S204 are repeated. In the case where the display control is finished, the flowchart in FIG. 2 is finished.

FIG. 3 is the flowchart illustrating the touch input control process at S202 illustrated in FIG. 2. Here, it is determined whether the control target that is scrolled depending on the pressing force when the user brings about the touch-move is the display target in the first display area 701 or the display target in the second display area 702.

The processes at S301 to S307 are performed after the touch input and will be described in detail later. The description starts with the process at S308.

At S308, the CPU 101 determines whether the touch-down occurs on the operation surface of the display 105. In the case where the touch-down does not occur, the touch input control is finished. In the case where the touch-down occurs, the flow proceeds to S309.

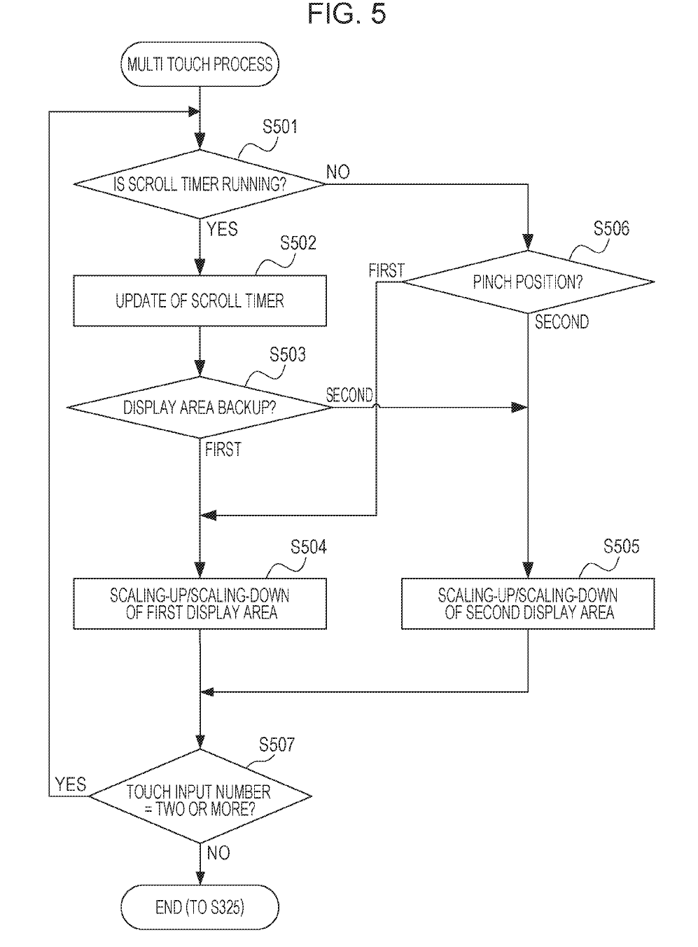

At S309, the CPU 101 determines the touch input number. The touch input number is the number of touch points of the touch input. In the case where the touch input number is two or more, the flow proceeds to S310, and a multi touch process is performed. The multi touch process at S310 will be described later with reference to the flowchart in FIG. 5. In the case where the touch input number is one, the flow proceeds to S311.

At S311, the CPU 101 determines whether the touch-move occurs. In the case where the touch-move does not occur, the flow proceeds to S312.

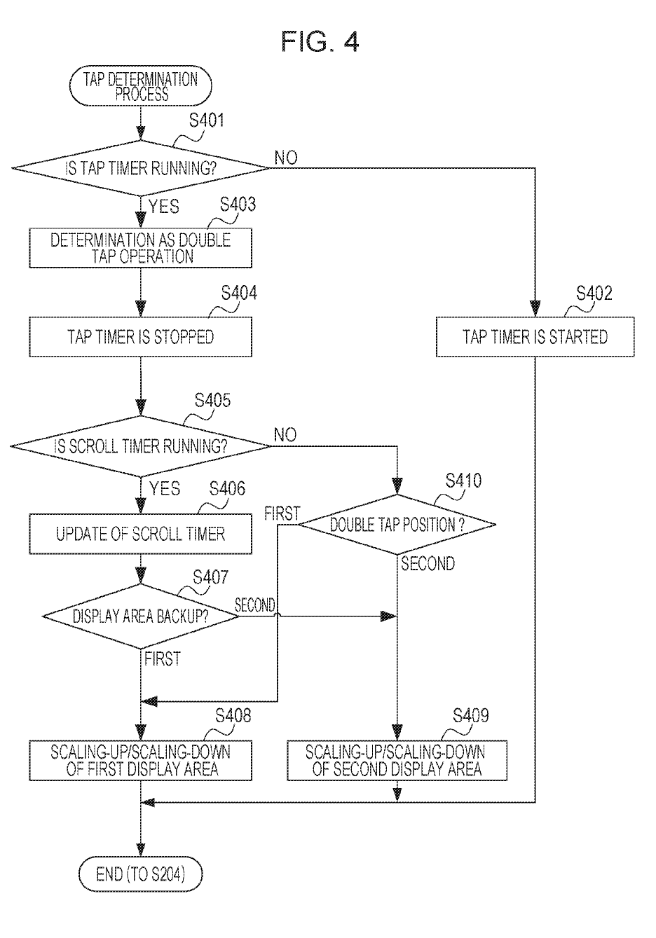

At S312, the CPU 101 determines whether the touch-up occurs. In the case where the touch-up occurs, the state becomes the touch-off because the touch-up occurs when the number of the touch point is one. The touch-up from the touch-move and the touch-up from a multi touch (pinch operation) are determined at S325 described later and are not included in the determination of the touch-up at S312. In the case where the touch-up occurs, the flow proceeds to S313, and a tap determination process is performed to determine whether this is the single tap operation or the double tap operation. The tap determination process at S313 will be described later with reference to the flowchart in FIG. 4. In the case where the touch-up does not occur, the flows returns to S309, and the processes are repeated.

In the case where the touch-move occurs at S311, the flow proceeds to S314.

At S314, the CPU 101 confirms the touch-move as scroll operation. The CPU 101 may confirm the touch-move as the scroll operation only in the case where the touch position when the touch-down occurs is within the first display area 701 and outside a functional area such as a touch button. Accordingly, the CPU 101 does not confirm the touch-move as the scroll operation and another process depending on the touch position is performed in the case where the touch position is outside the first display area 701 or within the functional area such as the touch button.

At S315, the CPU 101 determines whether a scroll timer is running. The scroll timer is one of timers that are started by using the system timer 111 and is used for monitoring elapsed time after the scroll operation. The scroll timer is set at time (first period) that is presumed when the user continuously carries out the scroll operation on the same display area of the first display area 701 and the second display area 702. The setting time is stored in the non-volatile memory 103 in advance. According to the present embodiment, the setting time of the scroll timer is, for example, 1 second. In the case where the double tap operation or the pinch operation is carried out while the scroll timer is running, the control target is the display target in the display area that has been scrolled just before the operation. The process performed by using the scroll timer will be described in detail later.

In the case where the scroll timer is not running at S315, the flow proceeds to S316.

At S316, the CPU 101 starts the scroll timer.

At S317, the CPU 101 obtains the pressing force of the touch-move to determine the display target in the display area to be controlled. Specifically, the CPU 101 obtains the pressing force that is detected by the pressure-detecting unit 113.

At S318, the CPU 101 determines the intensity of the pressing force. Specifically, the CPU 101 compares the obtained pressing force with a threshold (predetermined pressing force) to determine whether the pressing force is less than the threshold (less than the predetermined pressing force). The threshold is stored in the non-volatile memory 103 in advance. In the case where the pressing force is less than the threshold, the flow proceeds to S319.

At S319, the CPU 101 perceivably notifies the user of determination that the control target is the display target in the first display area 701. Specifically, as illustrated in FIG. 7B, the CPU 101 highlights the outer frame of the first display area 701 by a thick line. This enables the user to perceive that the display target in the first display area 701 is the control target for scrolling. Another notification method is also acceptable provided that the user can perceive that the control target is the display target in the first display area 701. For example, the color of the outer frame of the first display area 701 or the inside of the first display area 701 may be changed, and a display item such as an arrow that represents a scroll direction may be displayed outside the second display area 702 (at a position irrelevant to the second display area 702).

At S320, the CPU 101 causes the entire display target in the first display area 701 to be scrolled in response to the touch-move. Specifically, as illustrated in FIG. 7B to FIG. 7C, the display target is scrolled such that the display range of the display target (first display target) in the first display area 701 is changed together with a change in the display position of the display target (second display target) in the second display area 702.

At S321, the CPU 101 causes the memory 102 to store (backup) information that represents the control target is the display target in the first display area 701. Here, information about the first display area 701 is stored in the memory 102. The information is used to determine next operation to be controlled together with the scroll timer, and the detail thereof will be described later.

In the case where the pressing force is equal to or more than the threshold (predetermined pressing force or more) at S318, the flow proceeds to S322.

At S322, the CPU 101 perceivably notifies the user of determination that the control target is the display target in the second display area 702. Specifically, as illustrated in FIG. 7D, the CPU 101 highlights the outer frame of the second display area 702 by a thick line. This enables the user to perceive that the display target in the second display area 702 is the control target for scrolling. Another notification method is also acceptable provided that the user can perceive that the control target is the display target in the second display area 702. For example, the color of the outer frame of the second display area 702 or the inside of the second display area 702 may be changed, and a display item such as an arrow that represents a scroll direction may be displayed in the second display area 702.

At S323, the CPU 101 causes the display target in the second display area 702 to be scrolled in response to the touch-move. Specifically, as illustrated in FIG. 7D to FIG. 7E, the display target is scrolled such that only the display range of the display target (second display target) in the second display area 702 is changed. A part of the display target (first display target) in the first display area 701 and outside the display target (second display target) in the second display area 702 is not scrolled.

At S324, the CPU 101 causes the memory 102 to store (backup) information that represents that the control target is the display target in the second display area 702. Here, information about the second display area 702 is stored in the memory 102.

At S325, the CPU 101 determines whether the touch-up occurs. In the case where the touch-up occurs, the flow proceeds to S326. In the case where the touch-up occurs at this time, the touch-up occurs after the touch-move has occurred at least once, and the operation is not the single tap or the double tap.

At S326, the CPU 101 determines whether the touch-move corresponds to the flick operation. Specifically, the CPU 101 determines whether the touch-move occurs at the predetermined speed or more and the predetermined distance or more (operation is the flick operation) just before detection of the touch-up. In the case of the flick operation, the flow proceeds to S327. In the case of non-flick-operation, the touch input control is finished.

At S327, the CPU 101 updates the scroll timer. That is, the CPU 101 resets and restarts the scroll timer and counts up to timeout after the setting time has elapsed. The CPU 101 performs inertia scroll in response to the flick operation. Specifically, after the touch-up, the CPU 101 causes the control target that is represented by backup information that is stored in the memory 102 to be scrolled at an initial speed depending on the speed of the touch-move just before the touch-up, decreases the speed over time, and stops scrolling.

In the case where the touch-up does not occur at S325, the flow proceeds to S328.

At S328, the CPU 101 determines whether the touch-move occurs again. In the case where the touch-move occurs again, this is confirmed as the scroll operation, and the flow proceeds to S331. After S331, the CPU 101 determines that the control target for scrolling is the same display target as the display target in the display area that has been scrolled just before the operation although this will be described in detail later. The CPU 101 determines the display target in the display area that has been scrolled just before the operation on the basis of the backup information that is stored in the memory 102.

In the case where the touch-move does not occur at S328, the flow proceeds to S329.

At S329, the CPU 101 determines whether the touch input number is two or more. Specifically, the CPU 101 determines whether the touch input that is currently detected at a single point is not released, and the touch-down additionally occurs. In the case where the touch input number is two or more, the flow proceeds to S330, and the multi touch process is performed. The multi touch process at S330 will be described later with reference to the flowchart in FIG. 5. In the case where the touch input number is not two or more, the flow returns to S325, and the processes are repeated.

In the case where the scroll timer is running at S315 described above, the flow proceeds to S331. When the touch-move occurs again before the scroll timer is timed out, the flow proceeds from S315 to S331.

At S331, the CPU 101 updates the scroll timer. That is, the CPU 101 resets and restarts the scroll timer and counts up to timeout after the setting time has elapsed.

At S332, the CPU 101 determines the control target that has been scrolled just before the operation in order to set the control target for scrolling at the same display target as the display target in the display area that has been scroll just before the operation. Specifically, the CPU 101 determines the control target for scrolling by reading the backup information that is stored in the memory 102. In the case where the control target is the display target in the first display area 701, the flow proceeds to S333.

At S333, the CPU 101 determines whether the scroll operation on the display target in the first display area 701 can be accepted. In the case where the scroll operation can be accepted, the flow proceeds to S320. In the case where the scroll operation cannot be accepted, the CPU 101 restricts the scroll operation on the display target in the first display area 701, and the flow proceeds to S325. Specifically, the CPU 101 stops the process of scrolling the entire display target in the first display area 701. An example of the case where the scroll operation on the display target in the first display area 701 cannot be accepted is the case where the display target in the second display area 702 is displayed on the screen image while the entire display target in the first display area 701 is continuously scrolled. When the display target in the second display area 702 is displayed, the scroll operation on the display target in the first display area 701 is not thus accepted. This enables the user to check the content that is displayed in the second display area 702. The process at S333 may be omitted unless it is necessary to check the content that is displayed. In the case where scrolling the entire display target in the first display area 701 is stopped, the display target in the second display area 702 that is displayed on the screen image is preferably a display target that has not been displayed. The CPU 101 can determine whether the display target has been displayed in a manner in which information about the display target in the second display area 702 that has been displayed is stored in the memory 102.

In the case where the scroll operation cannot be accepted at S333, the CPU 101 may perform an additional process in which scrolling is stopped, a stop timer is subsequently started, and the scroll operation is not accepted until time (second period) that is set by the stop timer elapses. The setting time of the stop timer is stored in the non-volatile memory 103 in advance. However, the CPU 101 may accept the scroll operation on the display target in the second display area 702 and may cause the display target in the second display area 702 to be scrolled even before the setting time of the stop timer elapses. In this case, the user can check the content that is displayed in the second display area 702. In the case where the setting time of the stop timer has elapsed and the stop timer has timed out, the CPU 101 accepts the scroll operation on the display target in the first display area 701 and causes the entire display target in the first display area 701 to be scrolled.

In the case where the control target is the display target in the second display area 702 at S332, the flow proceeds to S323, and the CPU 101 causes the display target in the second display area 702 to be scrolled. That is, the CPU 101 causes the display target in the second display area 702 to be scrolled regardless of the pressing force and touch position of the scroll operation. In the case of continuous scroll operation, it is difficult to keep the pressing force constant. Accordingly, the control target for scrolling is set at the control target that is stored in the backup information. This enables the user to readily continue the continuous scroll operation regardless of the pressing force.

Unless it is necessary to consider operability, the control target for scrolling may be switched depending on the intensity of the pressing force when the scroll operation is carried out again as in the above process at S318. The same process as the process at S333 may be added between S332 and S323. Specifically, the CPU 101 determines whether the scroll operation on the display target in the second display area 702 can be accepted, and the flow proceeds to S323 in the case where the scroll operation can be accepted. In the case where the scroll operation cannot be accepted, the flow proceeds to S325, and the CPU 101 restricts the scroll operation on the display target in the second display area 702.

The process at S333 can be performed for the inertia scroll in response to the flick operation at S327. For example, the CPU 101 determines whether the flick operation on the display target in the first display area 701 or the second display area 702 can be accepted. In the case where the flick operation cannot be accepted, the CPU 101 restricts the flick operation on the display target in the first display area 701 or the second display area 702 and stops the process of scrolling the display target in the first display area 701 or the second display area 702.

Through the above processes, the control target for scrolling can be switched depending on the intensity of the pressing force of the touch-move. Consequently, for example, even when the user intends to carry out the scroll operation on the entire display target that is displayed in the first display area 701 but unintentionally touches the second display area 702, the whole is scrolled by the scroll operation with a weak force. That is, the user can scroll the intended target by rough operation without fine adjustment in the touch position. The control target can thus be switched depending on the pressing force, and the user can carry out desired operation.

At S318, the pressing force is determined regardless of the touch position (touch-down position) (or when the touch position is within the first display area 701). However, this is not a limitation. For example, the CPU 101 may determine whether the touch position is within the second display area 702 (on the display target in the second display area 702) and may make the determination only in the case where the touch position is within the second display area 702. That is, the flow proceeds to S319 regardless of the intensity of the pressing force in the case where the touch position is within the first display area 701 and outside the second display area 702. In this case, it can be presumed that the user does not intend to carry out the scroll operation in the second display area 702, and the CPU 101 causes the entire display target that is displayed in the first display area 701 to be scrolled in response to the touch-move regardless of the pressing force.

At S318, the flow proceeds to S322 and the display target in the second display area 702 is set at the control target for scrolling regardless of the touch position (touch-down position) (or when the touch position is within the first display area 701) in the case where the pressing force is equal to or more than the threshold. However, this is not a limitation. For example, the CPU 101 may determine whether the touch position is within the second display area 702 and may set the display target only in the case where the touch position is within the second display area 702. That is, even when the pressing force is equal to or more than the threshold at S318, the CPU 101 may omit the processes at S322 to S324 in the case where the touch position is outside the second display area 702. In this case, even when the user touches an area outside the second display area 702 to carry out the touch-move operation and the pressing force is equal to or more than the threshold, the CPU 101 invalidates the operation and does not cause the display target in all of the display areas to be scrolled.

At S332, the control target for scrolling is set at the same display target as the display target in the display area that has been scrolled just before the operation regardless of the touch position (touch-down position) of the scroll operation. However, the position of the scroll operation may be considered. Specifically, before the process at S331, the CPU 101 determines whether the touch position (touch-down position) when the scroll operation is carried out is within the second display area 702, and the process can be branched.

In the case where the touch position when the scroll operation is carried out is within the second display area 702, the above processes at S332 and later are performed. In the case where the touch position when the scroll operation is carried out is outside the second display area 702, the flow does not proceed to S332 but proceeds to S320, and the CPU 101 causes the entire display target in the first display area 701 to be scrolled.

Processes at S301 to S307 that are related to a process of clearing the backup information will now be described.

At S301, the CPU 101 determines whether the setting time of the scroll timer has elapsed and the scroll timer has timed out. In the case where the setting time has elapsed after scrolling just before the operation, the scroll timer has timed out. In the case where the scroll timer has timed out, the flow proceeds to S302.

At S302, the CPU 101 determines the control target that has been scrolled just before the operation. Specifically, the CPU 101 determines the control target for scrolling by reading the backup information that is stored in the memory 102. In the case where the control target is the display target in the first display area 701, the flow proceeds to S303. In the case where the control target is the display target in the second display area 702, the flow proceeds to S304.

At S303, the CPU 101 releases the notification that enables the user to perceive that the control target is the display target in the first display area 701. Specifically, the CPU 101 returns the outer frame of the first display area 701 to a normal line and finishes highlighting.

At S304, the CPU 101 releases the notification that enables the user to perceive that the control target is the display target in the second display area 702. Specifically, the CPU 101 returns the outer frame of the second display area 702 to a normal line and finishes highlighting.

At S305, the CPU 101 clears (deletes) the backup information that is stored in the memory 102. The processes at S303, S304, and S305 are performed to finish receiving various kinds of continuous operation with the scroll timer. Accordingly, when the scroll operation is carried out anew after the scroll timer has timed out, the intensity of the pressing force is determined again at S318, and the control target for scrolling is switched depending on the pressing force.

In the case where the scroll timer has not timed out at S301, the flow proceeds to S306.

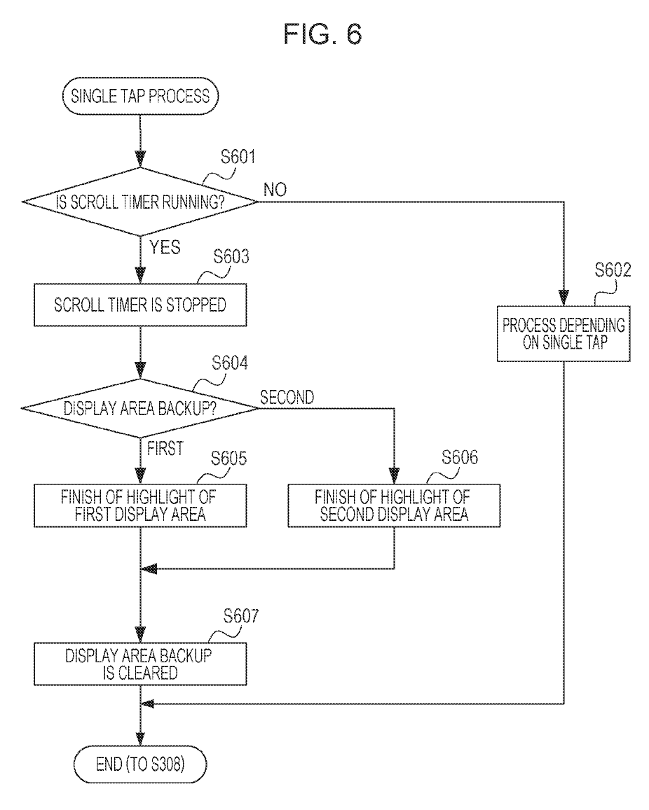

At S306, the CPU 101 determines whether the setting time of a tap timer has elapsed and the tap timer has timed out. The tap timer is running (the tap timer has not timed out) if the tap operation is carried out without the touch-move just before the operation and the setting time has not elapsed in the tap determination process at S313 described later. In the case where the tap timer has timed out, the touch operation is not the double tap operation in which taps continuously occur two times for a short time, but is single tap operation. Accordingly, the flow proceeds to S307, a single tap process is performed. The single tap process at S307 will be described later with reference to the flowchart in FIG. 6. In the case where the tap timer has not timed out, there is a possibility that the operation is the second tap of the double tap operation. Accordingly, the single tap process is not performed, and the flow proceeds to S308.

The processes at S308 and later are described above.

The above tap determination process at S313 will now be described with reference to the flowchart in FIG. 4.

At S401, the CPU 101 determines whether the tap timer is running. The tap timer is used to determine whether the operation is the double tap operation in which taps continuously occur two times for a short time or tap operation in which a single tap occurs, that is, the single tap operation. The tap timer is set at time of a tap period that is presumed when the user carries out the double tap operation. The setting time is stored in the non-volatile memory 103 in advance. According to present embodiment, the setting time of the tap timer is, for example, 0.5 seconds.

At the first time, the tap timer is not running. Accordingly, the flow proceeds to S402, and the CPU 101 starts the tap timer.

In the case where the tap operation is carried out just before the operation, and the setting time has not elapsed, the tap timer is running, and the flow proceeds to S403.

At S403, the CPU 101 confirms the tap operation as the double tap operation. That is, in the case where the tap timer is running, and the flow proceeds to S403, another tap operation has been carried out just before the operation. Accordingly, the CPU 101 can determine that the tap operation is the double tap operation. According to the present embodiment, the double tap operation is described as operation for scaling up and scaling down the screen image that is displayed.

At S404, the CPU 101 stops the tap timer. The reason why the tap timer is stopped is that the tap timer is not necessary after the double tap operation is confirmed.

At S405, the CPU 101 determines whether the scroll timer is running when the double tap operation is carried out. At this time, the setting time of the scroll timer is an example of a third period. According to the present embodiment, the first period and the third period are equal to each other but may be differ from each other. In the case where the scroll timer is running, the flow proceeds to S406.

At S406, the CPU 101 updates the scroll timer.

At S407, the CPU 101 determines the control target that has been scrolled just before the operation. Specifically, the CPU 101 determines the control target for scrolling by reading the backup information that is stored in the memory 102. The reason why the control target is determined is that the control target of the double tap operation is set at the same display target as the display area in the display target that has been scrolled just before the operation. That is, the control target of the double tap operation is set at the control target that has been scrolled just before the operation regardless of the pressing force and touch position of the double tap operation. In the case where the control target is the display target in the first display area 701, the flow proceeds to S408. In the case where the control target is the display target in the second display area 702, the flow proceeds to S409.

At S408, the CPU 101 sets the control target at the entire display target in the first display area 701 and causes the control target to be scaled up or scaled down. The control target is alternately scaled up and scaled down in every double tap operation.

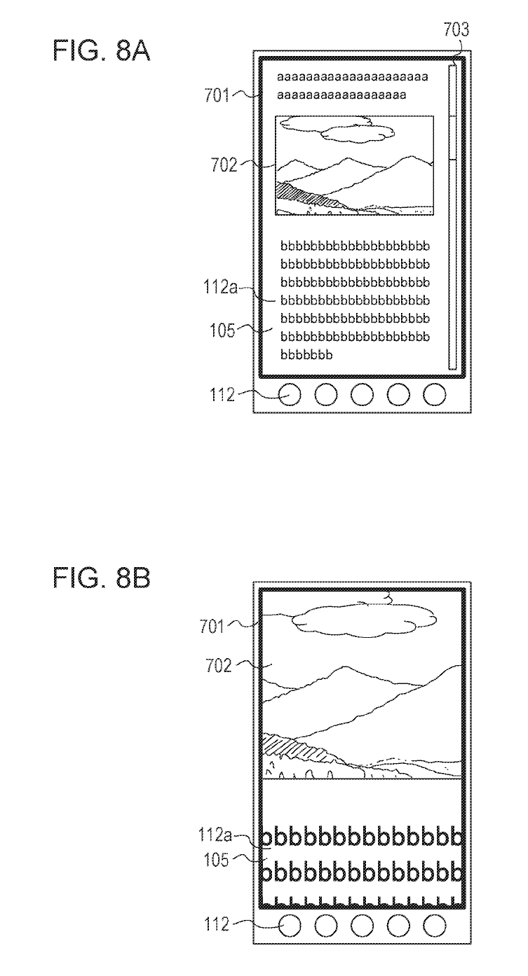

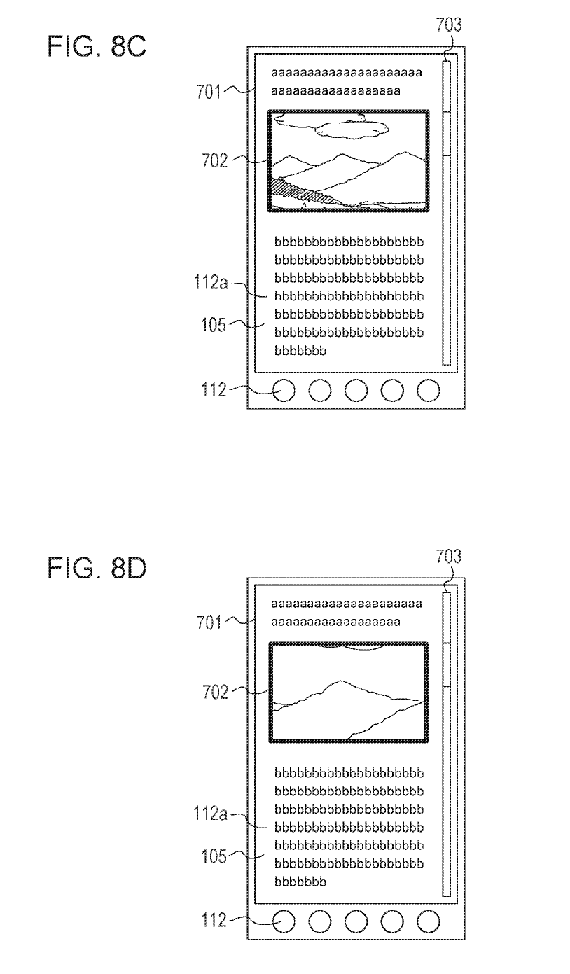

FIG. 8A and FIG. 8B illustrate examples of the screen image that is displayed on the display 105. In FIG. 8A, the outer frame of the first display area 701 is highlighted by a thick line, and the control target that has been scrolled just before the operation is the display target in the first display area 701. When the double tap operation is carried out in FIG. 8A, as illustrated in FIG. 8B, the entire display target that is displayed in the first display area 701 is scaled up. That is, the display target, such as letters, which is displayed in the first display area 701 and the second display area 702 itself are scaled up together. Accordingly, as illustrated in FIG. 8A to FIG. 8B, the size of the second display area 702 changes before and after scaling up. In FIG. 8B, the control target for scrolling is the display target in the first display area 701, and scaling up has been finished. When the double tap operation is carried out in FIG. 8B, as illustrated in FIG. 8A, the entire display target that is displayed in the first display area 701 is scaled down, and a magnification returns to that before scaling up. That is, the display target, such as letters, which is displayed in the first display area 701 and the second display area 702 itself are scaled down together. Accordingly, as illustrated in FIG. 8B to FIG. 8A, the size of the second display area 702 changes before and after scaling down.

At S409, the CPU 101 sets the control target at the display target in the second display area 702 and causes the control target to be scaled up or scaled down. The control target is alternately scaled up and scaled down in every double tap operation.

FIG. 8C and FIG. 8D illustrate examples of the screen image that is displayed on the display 105. In FIG. 8C, the outer frame of the second display area 702 is highlighted by a thick line, and the control target that has been scrolled just before the operation is the display target in the second display area 702. When the double tap operation is carried out in FIG. 8C, as illustrated in FIG. 8D, only the display target that is displayed in the second display area 702 is scaled up. That is, the size of the display target that is displayed in the first display area 701 and outside the second display area 702 does not change. Accordingly, as illustrated in FIG. 8C to FIG. 8D, the size of the second display area 702 does not change before and after scaling up.

In FIG. 8D, the control target for scrolling is the display target in the second display area 702, and scaling up has been finished. When the double tap operation is carried out in FIG. 8D, as illustrated in FIG. 8C, the display target that is displayed in the second display area 702 is scaled down, and the magnification returns to that before scaling up. The size of the display target that is displayed in the first display area 701 and outside the second display area 702 does not change. Accordingly, as illustrated in FIG. 8D to FIG. 8C, the size of the second display area 702 does not change before and after scaling down.

At S407, the control target for the double tap operation is set at the same display target as the display target in the display area that has been scrolled just before the operation regardless of the touch position (touch-down position) of the double tap operation. However, the touch position of the double tap operation may be considered. Specifically, before the process at S406, the CPU 101 determines whether the touch position (touch-down position) when the double tap operation is carried out is within the second display area 702, and the process can be branched. Examples of the case where the touch position of the double tap operation is within the second display area 702 include the case where the touch position of the first operation of the double tap operation, or the touch position of the second operation thereof, or both are within the second display area 702. However, it can be determined that the touch position of the double tap operation is within the second display area 702 in the case where the touch position of the first operation and the touch position of the second operation are within the second display area 702.

In the case where the touch position of the double tap operation is within the second display area 702, the above processes at S407 and later are performed. In the case where the touch position of the double tap operation is within the first display area 701 and outside the second display area 702, the flow does not proceed to S407 but proceeds to S408, and the CPU 101 causes the entire display target in the first display area 701 to be scaled up or scaled down.

In the case where the scroll timer is not running at S405, the flow proceeds to S410.

At S410, the CPU 101 determines the touch position of the double tap operation. In the case where the touch position of the double tap operation is within the first display area 701 and outside the second display area 702, the flow proceeds to S408, and the CPU 101 causes the entire display target in the first display area 701 to be scaled up or scaled down. In the case where the touch position of the double tap operation is within the second display area 702, the flow proceeds to S409, and the CPU 101 causes the display target in the second display area 702 to be scaled up or scaled down. Subsequently, the flow returns to S204.

The above multi touch process at S310 and S330 will now be described with reference to the flowchart in FIG. 5. Here, since the touch input number is two or more, the flow proceeds to S310 or S330. Accordingly, the CPU 101 confirms the touch the number of which is two or more as the pinch operation. The pinch operation is typically carried out by using two fingers. According to the present embodiment, however, the number of the fingers is not distinguished. Although the pinch operation includes a technique for changing a scaling-up ratio depending on the distance between the two fingers, scaling up or scaling down will be described herein for simplicity.

At S501, the CPU 101 determines whether the scroll timer is running when the pinch operation is carried out. At this time, the setting time of the scroll timer is an example of the third period. According to the present embodiment, the first period and the third period are equal to each other but may differ from each other. In the case where the scroll timer is running, the flow proceeds to S502.

At S502, the CPU 101 updates the scroll timer.

At S503, the CPU 101 determines the control target that has been scrolled just before the operation. Specifically, the CPU 101 determines the control target for scrolling by reading the backup information that is stored in the memory 102. The control target is determined to set the control target of the pinch operation at the same display target as the display target in the display area that has been scrolled just before the operation. That is, the control target of the pinch operation is set at the control target that has been scrolled just before the operation regardless of the pressing force and the touch positions of the pinch operation. In the case where the control target is the display target in the first display area 701, the flow proceeds to S504. As illustrated in FIG. 8A and FIG. 8B, the CPU 101 sets the control target at the display target in the first display area 701 and causes the entire display target in the first display area 701 to be scaled up or scaled down.

In the case where the control target is the display target in the second display area 702, the flow proceeds to S505. As illustrated in FIG. 8C and FIG. 8D, the CPU 101 sets the control target at the display target in the second display area 702 and causes the display target in the second display area 702 to be scaled up or scaled down.

In the case where the scroll timer is not running at S501, the flow proceeds to S506.

At S506, the CPU 101 determines the touch positions of the pinch operation. In the case where the touch positions of the pinch operation are within the first display area 701 and outside the second display area 702, the flow proceeds to S504, and the CPU 101 causes the entire display target in the first display area 701 to be scaled up or scaled down. In the case where the touch positions of the pinch operation are within the second display area 702, the flow proceeds to S505, and the CPU 101 causes the display target in the second display area 702 to be scaled up or scaled down. The control of the CPU 101 is such that the display target is scaled up when the distance between two points of the pinch operation increases, and the display target is scaled down when the distance decreases.

At S507, the CPU 101 determines whether the touch input number is two or more. In the case where the touch input number is two or more, the flow returns to S501, and the processes are repeated. In the case where the touch input number is not two or more, the processes are finished, and the flow returns to S325.

At S503, the control target of the pinch operation is set at the same display target as the display target in display area that has been scrolled just before the operation regardless of the touch positions of the pinch operation (touch-down position). However, the touch positions of the pinch operation may be considered. Specifically, before the process at S502, the CPU 101 determines whether the touch positions (touch-down position) when the pinch operation is carried out are within the second display area 702, and the process can be branched. The case where the touch positions of the pinch operation are within the second display area 702 can include the case where one of the touch positions of the pinch operation is within the second display area 702. However, it can be determined that the touch positions of the pinch operation are within the second display area 702 in the case where all of the touch positions of the pinch operation are within the second display area 702.

In the case where the touch positions of the pinch operation are within the second display area 702, the above processes at S503 and later are performed. In the case where the touch positions of the pinch operation are within the first display area 701 and outside the second display area 702, the flow does not proceed to S503 but proceeds to S504, and the CPU 101 causes the entire display target in the first display area 701 to be scaled up or scaled down.

The above single tap process at S307 will now be described with reference to the flowchart in FIG. 6. Here, since the setting time of the tap timer has elapsed and the tap timer has timed out, the flow proceeds to S307. Accordingly, the CPU 101 confirms the touch operation as the single tap operation.

At S601, the CPU 101 determines whether the scroll timer is running when the single tap operation is carried out. In the case where the scroll timer is not running, the flow proceeds to S602. In the case where the scroll timer is running, the flow proceeds to S603.

At S602, the control of the CPU 101 depends on the single tap operation. For example, when there is a touch button at the touch position of the single tap operation, the CPU 101 performs a function related to the touch button.

At S603, the CPU 101 stops the scroll timer.

At S604, the CPU 101 determines the control target that has been scrolled just before the operation. Specifically, the CPU 101 determines the control target for scrolling by reading the backup information that is stored in the memory 102. In the case where the control target is the display target in the first display area 701, the flow proceeds to S605. In the case where the control target is the display target in the second display area 702, the flow proceeds to S606.

At S605, the CPU 101 releases the notification that enables the user to perceive that the control target is the display target in the first display area 701. Specifically, the CPU 101 returns the outer frame of the first display area 701 to a normal line and finishes highlighting.

At S606, the CPU 101 releases the notification that enables the user to perceive that the control target is the display target in the second display area 702. Specifically, the CPU 101 returns the outer frame of the second display area 702 to a normal line and finishes highlighting.

At S607, the CPU 101 clears (deletes) the backup information that is stored in the memory 102, and the flow returns to S308.

The processes at S603 to S607 are performed to finish highlighting and the continuous operation in the scroll operation and may be omitted unless necessary or may be other processes.

According to the present embodiment described above, the CPU 101 changes the display range of the first display target together with the change in the display position of the second display target in response to the touch with the operation surface and the change in the touch position at less than the predetermined pressing force. The CPU 101 changes the display range of the second display target without movement of a part of the first display target outside the second display target in response to the touch with the operation surface and the change in the touch position at the predetermined pressing force or more. Accordingly, the display target the display range of which is changed is switched depending on the pressing force, and the user can readily change the display range of the desired display area.

In the case where the operation surface is touched again and the touch position changes when the CPU 101 changes the display range depending on the pressing force, the display range of the same display target as the display target the display range of which has been changed just before the operation is changed. Accordingly, the display range of the same display target as the display target the display range of which has been changed just before the operation can be changed regardless of the pressing force and the touch position. Consequently, the user does not need to care about the pressing force and the touch position and can change the display range of the desired display target.

According to the present embodiment, the entire display target in the first display area 701 is scrolled in the case where the pressing force of the touch-move is less than the predetermined pressing force, and the display target in the second display area 702 is scrolled in the case where the pressing force is the predetermined pressing force or more. However, this is not a limitation. For example, the display target that is switched depending on the pressing force may be reversed. Specifically, the CPU 101 may cause the entire display target in the first display area 701 to be scrolled in the case where the pressing force of the touch-move is the predetermined pressing force or more and may cause the display target in the second display area 702 to be scrolled in the case where the pressing force is less than the predetermined pressing force.

In the description according to the present embodiment, at S302, S332, S407, S503, or S604, the control target that has been scrolled just before the operation is determined. However, this is not a limitation. For example, at S302, S332, S407, S503, or S604, the CPU 101 may determine the control target that is switched (or determined) depending on the pressing force in scrolling previously.

In the description according to the present embodiment, various kinds of control described above is implemented by the CPU 101. However, this is not a limitation. The control may be implemented by a single piece of hardware, or plural pieces of hardware may share the processes to control the entire device.

The present invention is described in detail on the basis of a preferred embodiment. The present invention, however, is not limited to the above specific embodiment. Various embodiments are included in the present invention without departing from the spirit of the invention. The above embodiment is one of embodiments of the present invention. The above embodiment can be appropriately modified.

In the description according to the above embodiment, the present invention is applied to the electronic device 100 but is not limited thereto. The present invention can be applied to any device, provided that the device can detect the touch screen and the pressing force against the operation surface of the touch screen. That is, the present invention can be applied to, for example, a personal computer, a PDA, a cellular phone handset, a mobile image viewer, and a printing apparatus that includes a display. In addition, the present invention can be applied to household equipment and vehicle equipment that include a digital photo frame, a music player, a game console, an electronic book reader, a tablet terminal, a smart phone, a projector, or a display. The touch screen does not necessarily have a display function. For example, the present invention can be also applied to a note PC that includes a housing including a display and a housing including a keyboard and a touch pad (touch screen) having no display function and that can be folded. The touch operation on the touch pad can be dealt with for application in the same manner as the touch operation on the display 105 (the touch screen 112a) according to the above embodiment, provided that the pressing force against the operation surface of the touch pad can be detected (that is, the touch pad can be pressed).

### Other Embodiments

The present invention can also be carried out in a manner in which a system or the device is provided with a program for performing one or more functions according to the above embodiment via a network or a non-transitory storage medium, and one or more processors of a computer of the system or the device read and execute the program. The present invention can also be carried out by a circuit (for example, an ASIC) for performing one or more functions.

The present invention is not limited to the above embodiment. Various modifications and alterations can be made without departing form the spirit and scope of the present invention. Accordingly, the following claims are attached to publish the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An electronic device comprising:
a touch-detecting unit that is capable of detecting a touch with a display unit; and
a control unit that controls the display unit such that the display unit displays a content,
wherein, when a second content is displayed in an area within a first content, the control unit controls the display unit such that a display range of the first content is changed together with a change in a display position of the second content in response to a touch with an operation surface at less than a predetermined pressing force and a change in a touch position, and such that a display range of the second content is changed without movement of a part of the first content outside the second content in response to a touch with the operation surface at the predetermined pressing force or more and a change in the touch position.

2. The electronic device according to claim 1, wherein the control unit changes a color of a frame that represents a display area of the second content depending on a pressing force of the touch with the operation surface.

3. The electronic device according to claim 1, wherein the control unit changes the display range of the second content by scrolling, scaling up, or scaling down the second content in response to detection of the change in the touch position by the touch-detecting unit.

4. The electronic device according to claim 1, wherein the control unit controls the display unit such that a target the display range of which is changed in response to the change in the touch position is switched depending on a pressing force that is detected by a pressure-detecting unit regardless of the touch position when the operation surface is touched.

5. The electronic device according to claim 1, wherein the control unit determines which of the contents the display range of which is to be changed depending on a pressing force of the touch when the second content is touched.

6. The electronic device according to claim 1, wherein the control unit controls the display unit such that the display range of the first content is changed together with the change in the display position of the second content in response to the change in the touch position regardless of a pressing force of the touch when a part of the first content outside the second content is touched.

7. The electronic device according to claim 1, wherein the control unit controls the display unit such that the display range of each content is not changed in response to the change in the touch position when a part of the first content outside the second content is touched at the predetermined pressing force or more.

8. The electronic device according to claim 1, wherein the control unit controls the display unit such that the display range of the content the display range of which has been changed the last time is changed regardless of a pressing force of the touch when the touch position is changed again within a predetermined period after the change in the touch position.

9. The electronic device according to claim 8, wherein, when the touch position is changed after the predetermined period or more has elapsed, the control unit determines which of the contents the display range of which is to be changed depending on the pressing force of the touch when the touch position is changed after the predetermined period or more has elapsed.

10. The electronic device according to claim 1, further comprising: a pressing-force-detecting unit that detects a pressing force against the operation surface.

11. A method for controlling an electronic device that includes a touch-detecting unit that is capable of detecting a touch with a display unit, the method comprising:
a display control step of displaying a content on the display unit;
a control step of changing a display range of a first content together with a change in a display position of a second content in response to a touch with an operation surface at less than a predetermined pressing force and a change in a touch position when the second content is displayed in an area within the first content; and
a control step of changing a display range of the second content without movement of a part of the first content outside the second content in response to a touch with the operation surface at the predetermined pressing force or more and a change in the touch position when the second content is displayed in an area within the first content.

12. A non-transitory computer-readable storage medium that stores a program that is executable by a computer that executes the method according to claim 11 for controlling the electronic device.
